(19) United States
(12) Patent Application Publication
(10) Pub. No.: US 2018/0097694 A1
(43) Pub. Date: Apr. 5, 2018

(54) Dynamic Data-Based Deployment Sequencing

(71) Applicant: Microsoft Technology Licensing, LLC, Redmond, WA (US)

(72) Inventors: Zohar Raz, Redmond, WA (US); Divyachapan S. Padur, Bothell, WA (US); Ankur Jauhari, Bothell, WA (US); Roshane Silva, Seattle, WA (US)

(73) Assignee: Microsoft Technology Licensing, LLC, Redmond, WA (US)

(21) Appl. No.: 15/283,255

(22) Filed: Sep. 30, 2016

(51) Int. Cl. H04L 12/24; H04L 29/08; G06F 9/445; G06F 9/50

(52) U.S. Cl. CPC H04L 41/0816; H04L 67/306; H04L 67/22; G06F 9/5044; H04L 41/069; G06F 8/65; H04L 67/10

(57) ABSTRACT

In one example, a server farm updater may schedule application of a software change to a server farm based on a farm temperature value representing a dynamically determined level of customer interaction with the server farm. A server farm updater may maintain a customer profile for the server farm describing a customer interaction with the server farm. The server farm updater may apply a farm temperature describing a server farm usage based on the customer profile. The server farm updater may apply the software change to the server farm based on the farm temperature.

### BACKGROUND

A network service may allow multiple users to interact with data or an application via a data network. The data may be content on a website or a multi-share data file, accessible to be edited by multiple users. The application may be a software as a service application that a user purchases a yearly subscription to use. The user may use a client device to interact with the network service using a native application that interacts with the network service or a multi-purpose application, such as a web browser, that may retrieve the data. The network service may be maintained on the back end of a data connection with the client device by a set of servers, referred to as a server farm.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to scheduling application of a software change to a server farm based on a farm temperature value representing a dynamically determined level of customer interaction with the server farm. A server farm updater may maintain a customer profile for the server farm describing a customer interaction with the server farm. The server farm updater may apply a farm temperature describing a server farm usage based on the customer profile. The server farm updater may apply the software change to the server farm based on the farm temperature.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a data network for a single tenant service.

FIG. 2 illustrates, in a block diagram, one example of a data network for a multiple tenant service.

FIG. 3 illustrates, in a block diagram, one example of a computing device.

FIG. 4 illustrates, in a block diagram, one example of a server farm updater architecture.

FIG. 5 illustrates, in a block diagram, one example of farm temperature distribution.

FIG. 6 illustrates, in a block diagram, one example of a software change package.

FIG. 7 illustrates, in a block diagram, one example of a network container object.

FIG. 8 illustrates, in a flowchart, one example of a method for distributing farm temperatures.

FIG. 9 illustrates, in a flowchart, one example of a method for assigning a customer-specified farm temperature to a server farm.

FIG. 10 illustrates, in a flowchart, one example of a method for applying a farm temperature to a server farm.

FIG. 11 illustrates, in a flowchart, one example of a method for adjusting a farm temperature for a server farm.

FIG. 12 illustrates, in a flowchart, one example of a method for applying a software change.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a server farm updater, a computing device, or a machine-implemented method.

In one example, a server farm updater may schedule application of a software change to a server farm based on a farm temperature value representing a dynamically determined level of customer interaction with the server farm. A server farm updater may maintain a customer profile for the server farm describing a customer interaction with the server farm. The server farm updater may apply a farm temperature describing a server farm usage based on the customer profile. The server farm updater may apply the software change to the server farm based on the farm temperature.

A server farm supporting a network service may balance a tension between innovation speed and customer safety when applying a software change. Deploying too fast may cause customer instability and degraded experience, while deploying too slow may cause customer frustration in receiving the latest features and fixes. Additionally, each customer may be different, with some customers accepting change, while others preferring a higher level of stability. A server farm updater may wish to deploy fast to some customers, while providing more stability to other customers.

A dynamic farm temperature may be a micro service decoupled from a network service that serves both internal deployments as well as micro service deployments. A monitoring module of a server farm updater may assign a temperature value to a server farm supporting a network service. The monitoring module may examine the support databases that store the data points that are refreshed at a regular interval or on demand. The monitoring module may use the data points in a weighted sum algorithm. Each server farm, supplying one or more customers, may have a data point for each criterion defining customer interaction with those server farms. The monitoring module may give each criterion a weight coefficient that determines the significance of the data point in the calculation, based on business importance. For example, the usage data point may be twice as important as the incident history, thus having a coefficient of double. The monitoring module may vary the coefficients to achieve the optimal calculation for the application. The monitoring module may run this calculation for each server farm to produce a first intermediate farm temperature. The monitoring module may then sort the resulting values to produce a first intermediate sequence of server farms.

The monitoring module may apply randomization to allow for sequence variation, so that a server farm avoids being at a farm temperature in the sequence permanently. The monitoring module may select a few server farms from each temperature value and shuffle those temperature farms one temperature value upward or downward. This artificially mutated farm temperature may allow moderate variability. The monitoring module may modify the artificially mutated farm temperature for the business purpose. The highest temperature value may act as a critical watch list. The monitoring module may avoid the critical watch list for purposes of randomization. The critical watch list may contain the server farms with highest usage or worst recent experiences, and thus moving those server farms earlier in the deployment sequence may be counterproductive.

The monitoring module may apply manual overrides contained in a separate table indexed by a server farm identifier for an override temperature value. Thus, the monitoring module may manually place specific server farms in specific categories based on customer criteria. For example, the monitoring module may set a test environment or external partner validation environment to a low temperature value to allow for rapid deployment and validation before progressing to further server farms. The monitoring module may place the temperature values for these server farms in a table, also indexed by the server farm identifier. The table may contain the number of customer tenants for purpose of percentage calculations.

The server farm updater may use the temperature values to deploy a software change provided by a software provider. When a software provider has a payload to deploy to a customer server farm, the software provider may call an application programming interface of the server farm updater to get a list of server farm identifiers to deploy to in the first wave. The software provider may make the call by passing in a size of a sub-group of server farms, such as a percentage of customers or a percentage of total service population. If the size is ten percent, the monitoring module may return the set of server farms that hold the coolest ten percent of the customers by farm temperature. Similarly, the software provider may specify in the call a service environment or ring. The software provider or the server farm updater may then deploy the software change to the returned set of server farms. The service farm updater may repeat the cycle until each customer has been deployed to, with the coldest eligible set of server farms returned each time.

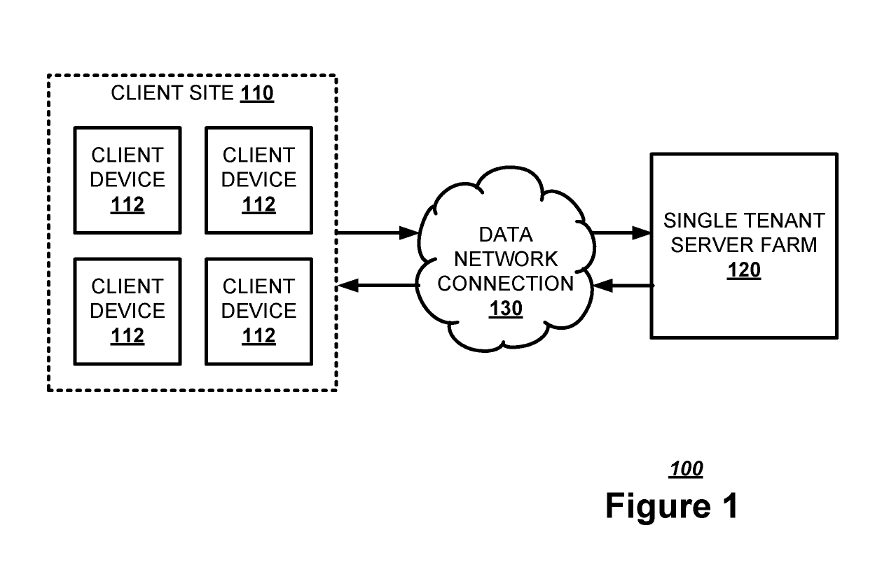

A server farm may provide service to a single tenant or multiple tenants. FIG. 1 illustrates, in a block diagram, one example of a data network 100 for a single tenant service. A client site 110 may have one or more client devices 112 that connect to a single tenant server farm 120 via a data network connection 130. The data network connection 130 may be an internet connection, a wide area network connection, a local area network connection, or other type of data network connections. The single tenant server farm 120 may have one or more servers dedicated to executing one or more network services for the single client site 110. Each client device 112 may execute a network service client to access the one or more network services or data maintained by the single tenant server farm 120. The network service client may be a separate application or integrated into an operating system or an internet browser platform. The single tenant server farm 120 may guarantee a set amount of resources to a client site 110. Further, the single tenant server farm 120 may more accurately track usage by the client site 110 to tailor the resources to the client site 110.

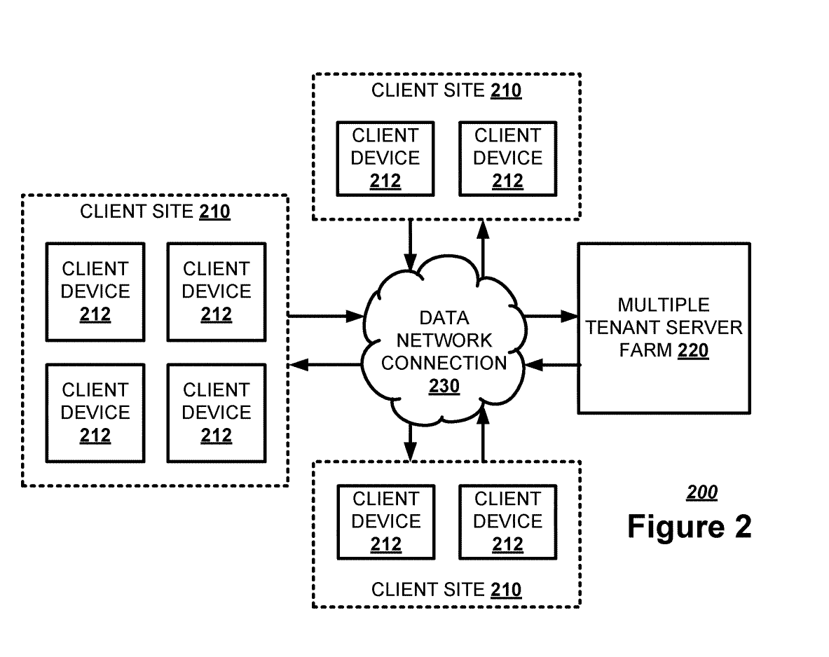

FIG. 2 illustrates, in a block diagram, one example of a data network 200 for a multiple tenant service. Multiple client sites 210 may share a multiple tenant server farm 220 via a data network connection 230. Each client site 210 may have one or more client devices 212. The multiple tenant server farm 220 may have one or more servers allocating one or more network services for each client site 210 based on client site usage. Each client device 212 may execute a network service client to access the one or more network services or data maintained by the multiple tenant server farm. The multiple tenant server farm 220 may efficiently and cheaply provide resources to the client sites 210 by redistributing resources from idle client sites 210 to active client sites 210. Thus, multiple tenant server farms 220 may tend to be more common than single tenant server farms, as well as having a higher volume of activity.

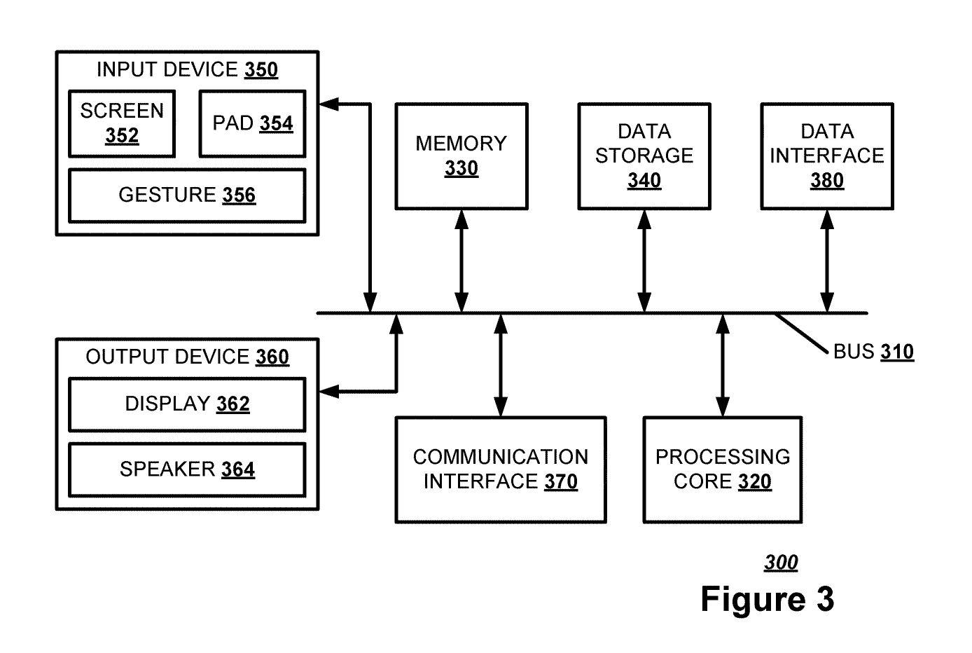

FIG. 3 illustrates a block diagram of an exemplary computing device 300 which may act as a server farm updater. The computing device 300 may combine one or more of hardware, software, firmware, and system-on-a-chip technology to implement a server farm updater. The computing device 300 may include a bus 310, a processing core 320, a memory 330, a data storage 340, an input device 360, an output device 360, a communication interface 370, and a data interface 380. The bus 310, or other component interconnection, may permit communication among the components of the computing device 300.

The processing core 320 may include at least one conventional processor or microprocessor that interprets and executes a set of instructions. The processing core 320 may be configured to apply a farm temperature describing a server farm usage based on a customer profile. The processing core 320 may assign the server farm to at least one of a single tenant server farm group and a multi-tenant server farm group. The processing core 320 may normalize the farm temperature between a single tenant server farm group and a multi-tenant server farm group.

The processing core 320 may select randomly the server farm to receive an artificially mutated farm temperature. The processing core 320 may assign an early adopter temperature to the server farm prioritizing application of the software change in an application cycle. The processing core 320 may assign the server farm to a critical watch list to delay application of the software change in an application cycle upon identifying a recent incident at the server farm. The processing core 320 may identify a recent incident at the server farm meriting assignment to a critical watch list to delay application of the software change in an application cycle. The processing core 320 may assign the server farm to a change freeze farm temperature blocking application of the software change for freeze period. The processing core 320 may monitor a customer interaction with the server farm. The processing core 320 may adjust the customer profile based on a customer profile based on a customer interaction of the server farm.

The processing core 320 may determine a change type of the software change. The processing core 320 may select an application protocol for the software change based on a change type for the software change. The processing core 320 may determine an application wave describing a farm group percentage based on a software charge package from a software provider describing the software change. The processing core 320 may generate an application schedule based on an application wave describing a farm group percentage and the farm temperature.

The memory 330 may be a random access memory (RAM) or another type of dynamic data storage that stores information and instructions for execution by the processing core 320. The memory 330 may also store temporary variables or other intermediate information used during execution of instructions by the processing core 320. The memory 330 may be configured to maintain a customer profile for the server farm describing a customer interaction with the server farm. The memory 330 may divide a server farm group containing the server farm into a set of farm temperature buckets.

The data storage 340 may include a conventional ROM device or another type of static data storage that stores static information and instructions for the processing core 320. The data storage 340 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 340 may store a set of instructions detailing a method that when executed by one or more processors cause the one or more processors to perform the method. The data storage 340 may also be a database or a database interface for storing a customer profile.

The input device 350 may include one or more conventional mechanisms that permit a user to input information to the computing device 300, such as a keyboard, a mouse, a voice recognition device, a microphone, a headset, a touch screen 352, a touch pad 354, a gesture recognition device 356, etc. The output device 360 may include one or more conventional mechanisms that output information to the user, including a display screen 362, a printer, one or more speakers 364, a headset, a vibrator, or a medium, such as a memory, or a magnetic or optical disk and a corresponding disk drive.

The communication interface 370 may include any transceiver-like mechanism that enables computing device 300 to communicate with other devices or networks. The communication interface 370 may include a network interface or a transceiver interface. The communication interface 370 may be a wireless, wired, or optical interface. The communication interface may be configured to receive a software change package from a software provider device describing the software change. The communication interface 370 may receive a customer notification opting for a specific schedule position in an application cycle for the software change. A data interface 380 may transmit data, software changes, or software actions, such as calls, between the computing device 300 and other computing devices 300. The data interface 380 may be configured to apply the software change to the server farm based on the farm temperature.

The computing device 300 may perform such functions in response to processing core 320 executing sequences of instructions contained in a computer-readable medium, such as, for example, the memory 330, a magnetic disk, or an optical disk. Such instructions may be read into the memory 330 from another computer-readable medium, such as the data storage 340, or from a separate device via the communication interface 370.

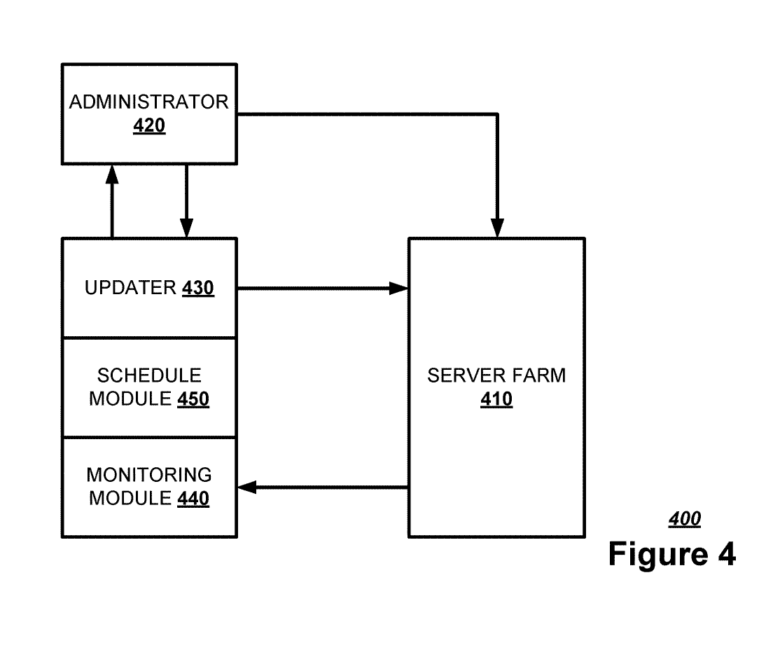

FIG. 4 illustrates, in a block diagram, one example of a server farm updater architecture 400. The server farm 410 may be a collection of servers that act to provide one or more network services to one or more client sites. An administrator 420 may update a server farm 410 by applying a software change to one or more servers in the server farm 410. The software change may be a new application module or a change to an existing application module. The administrator 420 may use an updater module 430 to apply a software change to multiple servers in the server farm 410. The updater module 430 may be a separate server or servers that interact with the other servers in the server farm 410 or an application that moves from server to server. The updater module 430 may be self-actualizing code within the software change. The updater module 430 may apply the software change to the server farm 410 in groups of servers based on a wave distribution pattern. The wave distribution pattern may describe a wave of server farms to receive the software change as either a number of servers or a percentage of server farms to receive the software change.

A monitoring module 440 may monitor the interaction level of a server farm 410 by a customer. The monitoring module 440 may measure the interaction level based on traffic with a customer, processing usage, resource usage, or other metrics measuring performance of the server farm 410. The monitoring module 440 may use the interaction level to dynamically assign a farm temperature to the server farm. The farm temperature may describe customer interaction with the server farm 410. The monitoring module 440 may change the farm temperature of a server farm 410 as the interaction level changes over time.

A schedule module 450 may generate a schedule for applying the software change to the server farms 410 controlled by the administrator 420. The schedule module 450 may determine the number of server farms 410 to receive an application of the software change at a given time based upon the wave distribution pattern. The schedule module 450 may then select which server farms 410 to receive the software change in the wave based on the farm temperature.

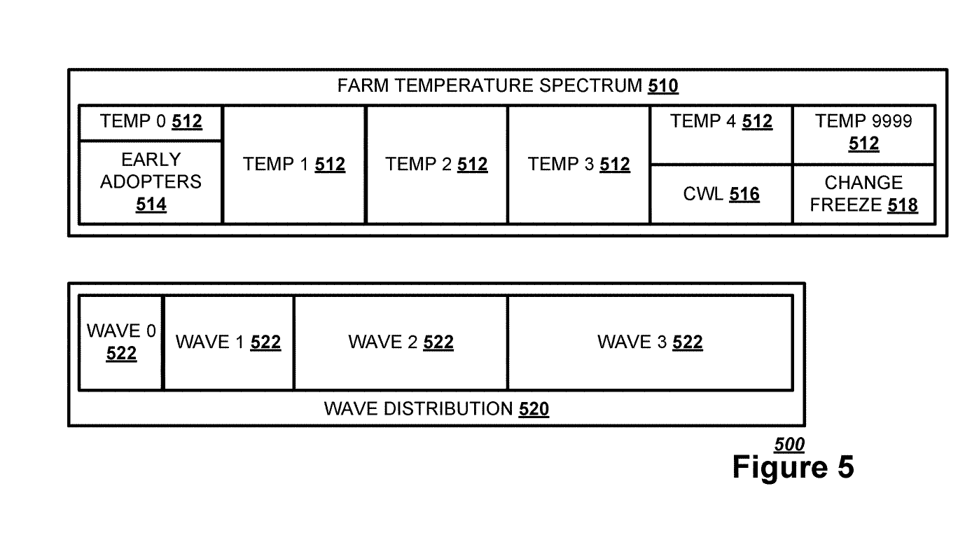

FIG. 5 illustrates, in a block diagram, one example of farm temperature distribution 500. A server farm updater may place a server farm from a set of server farms serviced by the server farm updater to a position on a farm temperature spectrum 510 representing interaction by one or more clients. The farm temperature spectrum 510 may be divided into multiple farm temperature buckets 512 representing a group of server farms. The set of server farms may be distributed evenly across the server farm buckets 512. Alternately, some farm temperature buckets 512 may contain more server farms than others. The server farm updater may assign the server farm to a farm temperature bucket 512 based on an interaction level of customers with the server farm, referred to as farm temperature. The server farm updater may initially assign a farm temperature bucket 512 by ordering the server farms by farm temperature, then dividing the server farms into farm temperature buckets 512. The server farm updater may assign a server farm with a high level of interaction by clients to a farm temperature bucket 512 at one end of the farm temperature spectrum 510 while assigning a server farm with a low level of interaction by clients to a farm temperature bucket 512 at the other end of the farm temperature spectrum 510. The server farm updater may monitor the customer interaction of the server farm, either directly or by receiving updates from the server farm. The server farm updater may move the server farm to a different farm temperature bucket 512 as the interaction level of a server farm changes.

A single tenant server farm may generally have a lower level of interaction than a multi-tenant server farm. If the server farm updater assigns a single tenant server farm using the same interaction criteria as a multi-tenant server farm, the single tenant server farm may end up heavily weighted to a specific farm temperature bucket 512. To counteract this imbalance, the server farm updater may normalize the farm temperature between a single tenant server farm and a multi-tenant server farm. For example, the server farm updater may assign the server farm to a single tenant server farm group or a multi-tenant server farm group. The server farm updater may then assign each server farm of the single tenant server farm group to a farm temperature bucket 512 based on the other server farms in the single tenant server farm group, while excluding the server farms from the multi-tenant server farm group from consideration. Similarly, the server farm updater may then assign each server farm of the multi-tenant server farm group to a farm temperature bucket 512 based on the other server farms in the multi-tenant server farm group, while excluding the server farms from the single tenant server farm group from consideration. Thus, a single tenant server farm assigned to farm temperature bucket 3 512 has the same interaction level comparative to the rest of the single tenant server farm group as a multi-tenant server farm in farm temperature bucket 3 512 comparative to the rest of the multi-tenant server farm group. Alternately, the server farm updater may apply a normalizing weight to an interaction metric of a single tenant server farm to make a comparison with an interaction metric for a multi-tenant server farm more comparable.

A server farm in a farm temperature bucket 512 at one end of the farm temperature spectrum 510 may receive a software change before a server farm in a farm temperature bucket 512 farther down the farm temperature spectrum 510. The server farm updater may designate a farm temperature bucket 512, such as farm temperature bucket 0 512, as an early adopter bucket 514. A server farm in the early adopter bucket 514 receives a software change before a server farm in any of the other farm temperature bucket 514. The server farm updater may assign a server farm with a low interaction metric to the early adopter bucket 514, so that any bugs in the software change have a minimal negative effect. Additionally, a customer of the server farm may be connected with the software provider. The server farm customer may be monitoring the server farm to test a software change. The server farm customer may request that the server farm administrator assign a specific server farm to the early adopter bucket 514, either generally or for specific software changes.

The server farm updater may designate a farm temperature bucket 512, such as farm temperature bucket 4 512 of five active farm temperature buckets 512, as a critical watch list (CWL) bucket 516. A server farm in the critical watch list bucket 516 receives a software change after the server farms in every other farm temperature bucket 512. The server farm updater may assign a server farm with a high interaction metric to the critical watch list bucket 516, so that any bugs in the software change have a minimal negative effect. Alternately, the server farm may have been a victim of a serious change issue. The server farm updater may assign the server farm to the critical watch list bucket 514 to prevent repeated issues or to preserve service during a critical period.

Additionally, a customer of the server farm may be in the midst of period of activity when an update to the server farm may be problematic. The server farm updater may receive a customer notification requesting a change freeze for the server farm to block application of a software change for a freeze period, or a limited time provided by the customer during which no software changes are applied. The server farm updater may designate a farm temperature bucket 512, such as farm temperature bucket 9999 512, acting as a change freeze temperature bucket 518. The server farm updater may assign the server farm to the change freeze temperature bucket 518 for the freeze period. The server farm updater may block application of a software change to a server farm in the change freeze temperature bucket 518.

A server farm updater may randomly select a server farm to receive an artificially mutated farm temperature. The artificially mutated farm temperature places the server farm in a farm temperature bucket 512 different from one warranted by the actual interaction level of that server farm. The server farm updater may use the artificially mutated farm temperature to prevent a single server farm from being constantly subjected to the initial wave of software changes.

The server farm updater may receive a software change from a software provider device for application to the server farms. The software provider may specify a wave distribution pattern 520 for the software change. The wave distribution pattern 520 may describe a series of waves 522 for applying the software change to the server farms. For example, the software provider may specify that the server farm updater is to apply the software change to five percent of the server farms in wave 0 522, twenty percent of the server farms in wave 1 522, twenty-five percent of the server farms in wave 2 522, and fifty percent of the server farms in wave 3 522. In this way the software provider may control for any bugs or other errors found in the software change. The server farm updater may select which server farms are included in which wave 522 based upon the farm temperature. The wave distribution pattern 520 may be orthogonal to the farm temperature spectrum 510, in that the number of waves 522 may not match the number of farm temperature buckets 512. Further, a wave 522 may involve fewer server farms than present in a server farm bucket 512.

Additionally, a customer may want a software change to be applied to the server farm during a specific wave 522. The customer may send a customer notification to the administrator opting for a specific schedule position in an application cycle of the software change. The customer side application may generate the customer notification by providing a slider that the customer may position within a slider bar representing the application cycle to indicate when the customer wants a software change applied.

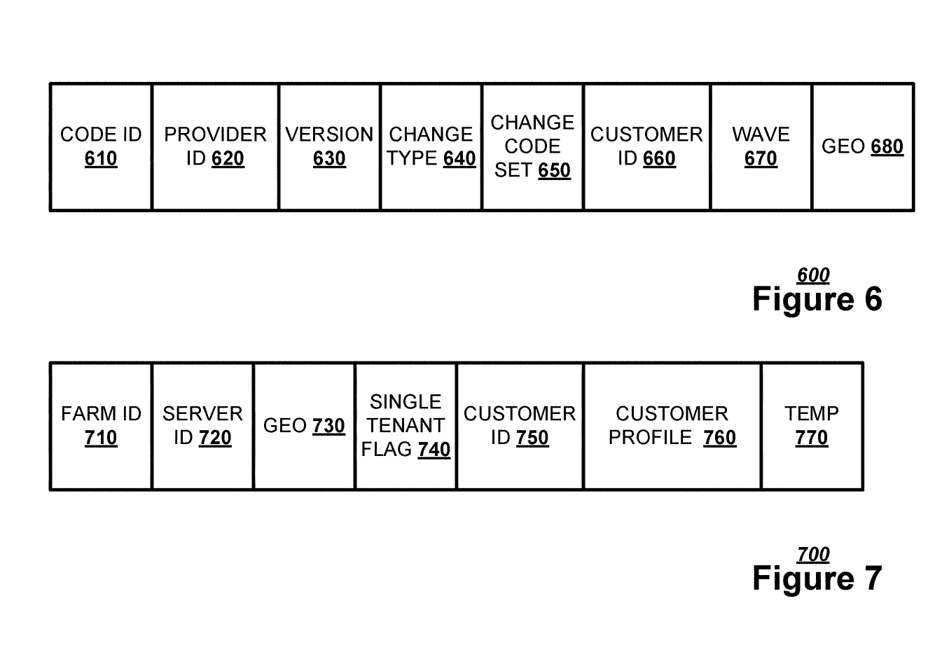

FIG. 6 illustrates, in a block diagram, one example of a software change package 600. The software change package 600 may have a code identifier (ID) 610 to identify the software change. The software change package 600 may have a provider identifier 620 to identify the software provider submitting the software change. The software change package 600 may have a version number 630 to identify which version of the software change is contained in the package. The software change package 600 may have a change type 640 to identify the type of software change is contained in the package. The software change package 600 may have a software change code set 650 for application to the server application. The software change package 600 may have an array of one or more customer identifiers 660, indicating customers that are to receive the software change. The software change package 600 may have a wave field 670 to describe a wave distribution pattern for applying the software change code set 650 to the server farms. The software change package 600 may have a geographic region field 680 to indicate that the software change code set 650 is to be applied to server farms in the listed geographic region.

FIG. 7 illustrates, in a block diagram, one example of a network container object 700 used to describe the server farm to the server farm updater. The network container object 700 may have a server farm identifier 710 identifying the server farm described by the network container object 700. The network container object 700 may have an array of one or more server identifiers 720 identifying servers present in the server farm. The network container object 700 may have a geographic location field 730 describing the geographic location of the server farm. The network container object 700 may have a single tenant flag 740 that indicates if the server farm is a single tenant server farm dedicated to a single client. The network container object 700 may have an array of one or more customer identifiers 750 indicating customers served by the server farm. The network container object 700 may have a customer profile field 760 describing a customer interaction with the server farm. The network container object 700 may have a farm temperature rating 770 describing a server characteristic that the server farm updater may use to determine an updating order.

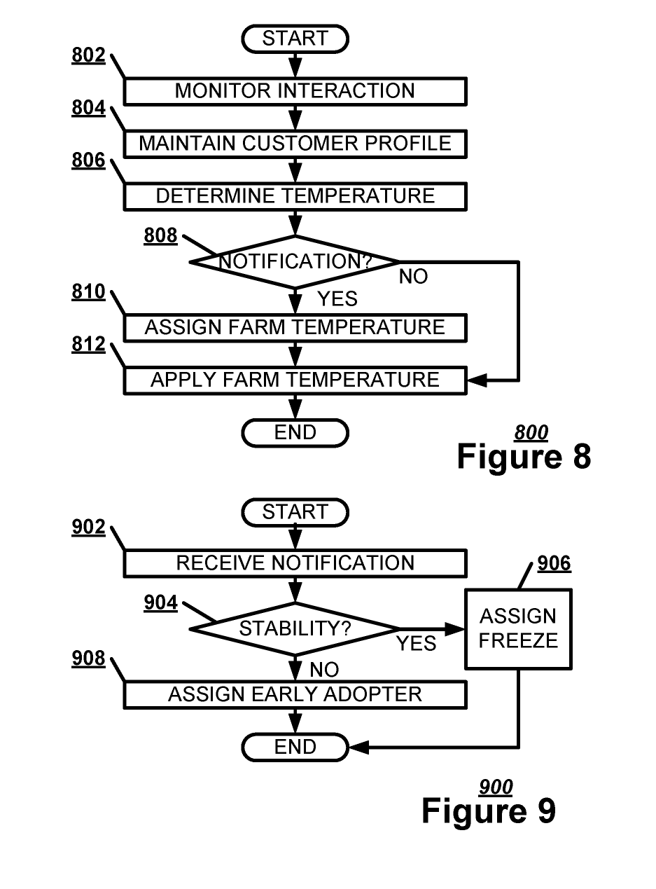

FIG. 8 illustrates, in a flowchart, one example of a method 800 for distributing farm temperatures. A server farm updater may monitor a customer interaction with a server farm (Block 802). The server farm updater may maintain a customer profile for the server farm describing the customer interaction with the server farm (Block 804). The server farm updater may determine a farm temperature for the server farm (Block 806). If the server farm updater receives a customer notification opting for a specific schedule position in an application cycle for the software change (Block 808), the server farm updater may assign a specific farm temperature to the server farm based on the specific schedule position to schedule application of a software change in an application cycle (Block 810). The server farm updater may apply the farm temperature describing a server farm usage based on the customer profile (Block 812). FIG. 9 illustrates, in a flowchart, one example of a method 900 for assigning a customer-specified farm temperature to a server farm. A server farm updater may receive a customer notification opting for a specific schedule position in an application cycle for the software change (Block 902). If the server farm updater receives a customer notification opting for stability by requesting a change freeze for the server farm to block application of a software change for a freeze period (Block 904), the server farm updater may assign the server farm to a change freeze farm temperature blocking application of a software change for freeze period (Block 906). If the customer notification indicates the customer prefers speed of software change application over stability (Block 904), the server farm updater may assign an early adopter temperature to the server farm prioritizing application of the software change in an application cycle (Block 908).

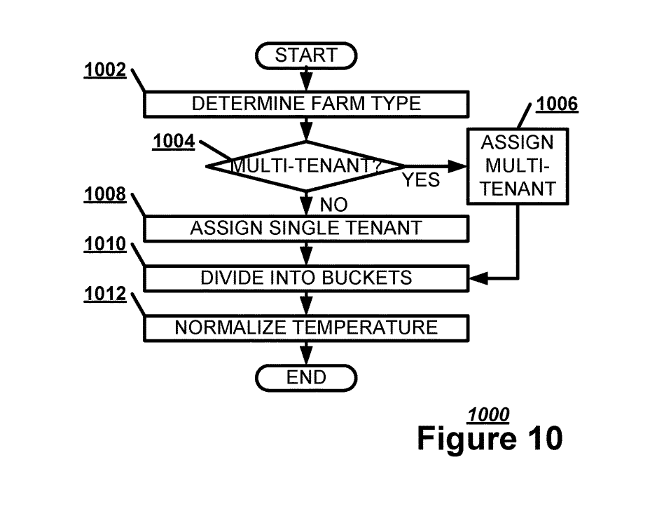

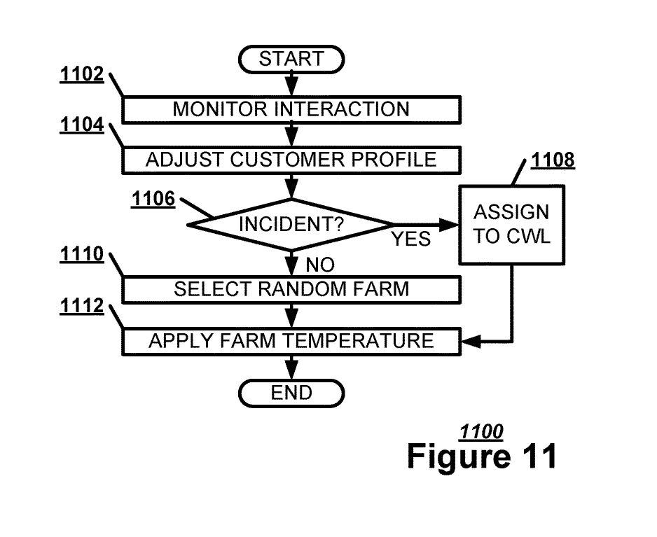

FIG. 10 illustrates, in a flowchart, one example of a method 1000 for applying a farm temperature to a server farm. The server farm updater may determine a farm type for a server farm (Block 1002). If the server farm is a multi-tenant server farm (Block 1004), the server farm updater may assign the server farm to a multi-tenant server farm group (Block 1006). If the server farm is a single tenant server farm (Block 1004), the server farm updater may assign the server farm to a single tenant server farm group (Block 1008). The server farm updater may divide a server farm group containing the server farm into a set of farm temperature buckets (Block 1010). The server farm updater may normalize the farm temperature between the single tenant server farm group and the multi-tenant server farm group (Block 1012).

FIG. 11 illustrates, in a flowchart, one example of a method 1100 for adjusting a farm temperature for a server farm. A server farm updater may monitor a customer interaction with a server farm (Block 1102). The server farm updater may adjust the customer profile based on a customer interaction of the server farm (Block 1104). If the server farm updater identifies a recent incident at the server farm meriting assignment to a critical watch list (Block 1106), the server farm updater may assign the server farm to a critical watch list to delay application of the software change in an application cycle (Block 1108). The server farm updater may select randomly the server farm to receive an artificially mutated farm temperature (Block 1110). The server farm updater may apply a farm temperature describing a server farm usage based on the customer profile (Block 1112).

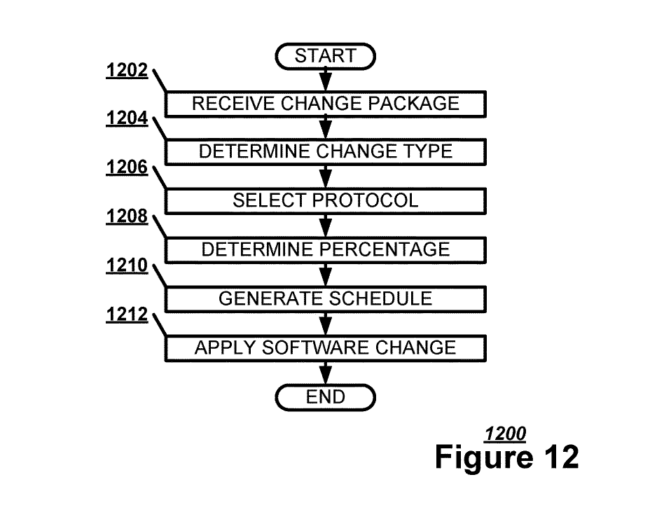

FIG. 12 illustrates, in a flowchart, one example of a method 1200 for applying a software change. The server farm updater may receive a software change package from a software provider device describing the software change (Block 1202). The server farm updater may determine a change type for the software change (Block 1204). The server farm updater may select an application protocol for the software change based on a change type for the software change (Block 1206). The server farm updater may determine an application wave describing a farm group percentage based on a software change package from a software provider describing the software change (Block 1208). The server farm updater may generate an application schedule based on an application wave describing a farm group percentage and the farm temperature (Block 1210). The server farm updater may apply the software change to the server farm based on the farm temperature (Block 1212).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A server farm updater, comprising:
memory configured to maintain a customer profile for the server farm describing a customer interaction with the server farm;
a processing core having at least one processor configured to apply a farm temperature describing a server farm usage based on the customer profile; and
a data interface configured to apply the software change to the server farm based on the farm temperature.

2. The server farm updater of claim 1, wherein the processing core is configured to monitor the customer interaction with the server farm.

3. The server farm updater of claim 1, wherein the memory is configured to divide a server farm group containing the server farm into a set of farm temperature buckets.

4. The server farm updater of claim 1, wherein the processing core is configured to assign the server farm to at least one of a single tenant server farm group and a multi-tenant server farm group.

5. The server farm updater of claim 1, wherein the processing core is configured to normalize the farm temperature between a single tenant server farm group and a multi-tenant server farm group.

6. The server farm updater of claim 1, wherein the processing core is configured to select randomly the server farm to receive an artificially mutated farm temperature.

7. The server farm updater of claim 1, wherein the processing core is configured to adjust the customer profile based on the customer interaction of the server farm.

8. The server farm updater of claim 1, further comprising:
a communication interface configured to receive a software change package from a software provider device describing the software change.

9. The server farm updater of claim 1, wherein the processing core is configured to determine a change type for the software change.

10. The server farm updater of claim 1, wherein the processing core is configured to select an application protocol for the software change based on a change type for the software change.

11. The server farm updater of claim 1, wherein the processing core is configured to determine an application wave describing a farm group percentage based on a software change package from a software provider describing the software change.

12. The server farm updater of claim 1, wherein the processing core is configured to generate an application schedule based on an application wave describing a farm group percentage and the farm temperature.

13. A computing device, having a memory to store a series of instructions that are executed by at least one processor to apply a software change to a server farm, the computing device configured to
monitor a customer interaction with the server farm;
maintain a customer profile for the server farm describing the customer interaction with the server farm;
apply a farm temperature describing a server farm usage based on the customer profile; and
apply the software change to the server farm based on the farm temperature.

14. The computing device of claim 13, wherein the computing device is further configured to
receive a software change package from a software provider device describing the software change.

15. The computing device of claim 13, wherein the computing device is further configured to
receive a customer notification opting for a specific schedule position in an application cycle for the software change.

16. The computing device of claim 13, wherein the computing device is further configured to
assign the server farm to a change freeze farm temperature blocking application of the software change for freeze period.

17. The computing device of claim 13, wherein the computing device is further configured to
assign an early adopter temperature to the server farm prioritizing application of the software change in an application cycle.

18. The computing device of claim 13, wherein the computing device is further configured to
assign the server farm to a critical watch list to delay application of the software change in an application cycle upon identifying a recent incident at the server farm.

19. A machine-implemented method, comprising:
maintaining a customer profile for a server farm describing a customer interaction with the server farm;
applying a farm temperature describing a server farm usage based on the customer profile;
receiving a software change package from a software provider device describing a software change; and
applying a software change to the server farm based on the farm temperature.

20. The method of claim 19, further comprising:
dividing a server farm group containing the server farm into a set of farm temperature buckets.
